(19) United States
(12) Patent Application Publication
(10) Pub. No.: US 2005/0216835 A1
(43) Pub. Date: Sep. 29, 2005

(54) Drawing input apparatus, drawing input program and drawing input method

(75) Inventors: Katsushi Aoki, Kawasaki (JP); Rimi Mizuno, Kawasaki (JP); Eiji Furukawa, Kawasaki (JP); Kenya Takeyama, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/889,065

(22) Filed: Jul. 13, 2004

(30) Foreign Application Priority Data
Mar. 25, 2004 (JP) 2004-088778

(51) Int. Cl. G06F 17/24

(52) U.S. Cl. 715/530; 345/441; 715/502

(57) ABSTRACT

The present invention as disclosed hereby is to provide a drawing input apparatus, drawing input program and drawing input method. The drawing input apparatus comprising: a drawing inputting/editing portion adapted to input or edit drawing data; a rule information storing portion adapted to store therein rule information defining rules for inputting or editing the drawing data; and a rule checking portion adapted to check by using the rule information a part which is present in the drawing data and which is modified based on a predetermined operation on the condition that said drawing inputting/editing portion executes such a predetermined operation.

### BACKGROUND OF THE INVENTION

1. Field of the Invention

The present invention relates to a drawing input apparatus, a drawing input program and a drawing input method.

2. Description of the Related Art

Recently, an inputted or edited operation of a drawing is executed by using a CAD in a drawing input apparatus. In the event that rules (design rules etc.) with respect to an input or edition of a drawing are defined, an operation of Design-Rule-Check (hereinafter referred to as “DRC”) is executed after input of the drawing in order to correct an infraction of the rules (such as a design miss) found in the inputted or edited drawing. Examples of such a technology are disclosed in the following Japanese Laid-Open Patent Publication Nos. 03-282681 (pp. 2-3, FIG. 1); 4-68472 (pp. 2-3. FIG. 1); and 07-141404 (pp. 3-4 FIG. 1). The disclosures of these references are herein incorporated in their entirely by reference thereto.

A designer will perform correction of his designed drawing based on errors information found in the drawing and obtained by the DRC operation.

In FIG. 29, there is a schematic diagram showing a conventional drawing input apparatus. As shown in FIG. 29, the drawing input apparatus comprises: an operation inputting portion 901 (such as a key-board and mouse) from which an operational input is supplied to the drawing input apparatus; a displaying portion 902 adapted to display the inputted or edited drawing thereon; a drawing display processing portion 904 serving as an interface for displaying drawing data on the displaying portion 902; a drawing inputting and/or editing portion M adapted to input or edit the drawing; a drawing data storing portion 906 adapted to store therein data on the inputted or edited drawing; a library 907 adapted to store therein information of constituents of the drawing; and a non-shown DRC executing portion adapted to execute the DRC (Design-Rule-Check) on the inputted or edited drawing. In particular, the drawing inputting and/or editing portion M comprises a drawing data editing I/F 903 and a drawing data operating portion 905.

This drawing data editing I/F 903 serves as an interface for transmitting operation inputs from the operation inputting portion 901 to the drawing display processing portion 904 or the drawing data operating portion 905. The drawing data operating portion 905 performs reading and/or writing of the drawing data stored in the drawing data storing portion 906.

In the conventional drawing input apparatus as described above, the drawing inputting/editing portion M and the non-shown DRC executing portion are independently from each other and not configured for executing respective processing in association with each other. More specifically, the drawing inputting operation or editing operation is executed as distinct with the DRC operation (i.e., the drawing inputting/editing operation is executed in a different phase than that in which the DRC operation is executed.). Thus, even if a design miss is present on the way to input or edit the drawing, the designer does not recognize the presence of the design miss unless the DRC operation is executed. Therefore, a substantial redo of designs has often been disadvantageously caused.

Also, since any error information of the design miss that has been detected by the DRC operation does not sufficiently correspond to the drawing displayed on a display screen, the designer himself performs a management of such a correspondence relationship (which induces a management cost). Further, if there is generated a mistake in managing the correspondence relationship (e.g., non-corresponding with the number of drawing editions), a wasted cost for analyzing the mistake is induced.

Yet further, when the drawing is corrected based on error information obtained as a result of the DRC operation, it is necessary to retrieve in the drawing locations to be corrected from drawing database using the error information. As a result, this puts obstacles in the way of an improvement of efficiency in the correcting operation.

Furthermore, although there is a technology in that a relationship between constituents for constituting a drawing is checked in a batch processing, it is difficult to rapidly find any design miss. This technology disadvantageously leads to an expansion of correction range and an increase of process steps.

The aforementioned problems lower efficiency of drawing inputting operation and correcting operation and increase a burden on the designer.

### SUMMARY OF THE INVENTION

In order to solve the above-mentioned problems, an object of the present invention is to provide a drawing input apparatus, a drawing input program and a drawing input method, thereby realizing an improvement of efficiency of a drawing inputting operation and drawing correcting operations and then contributing to an alleviation of a burden on the designer.

According to one aspect of the present invention, there is provided a drawing input apparatus, characterized by comprising:
a drawing inputting/editing portion adapted to input or edit drawing data;
a rule information storing portion adapted to store therein rule information defining rules for inputting or editing the drawing data; and
a rule checking portion adapted to check by using the rule information a part which is present in the drawing data and which is modified based on a predetermined operation on the condition that said drawing inputting/editing portion executes such a predetermined operation.

With this configuration, a drawing inputting/editing operation is not executed in a different phase than that in which a rule checking operation is executed so that the rule checking operation is dynamically executed during the drawing inputting/editing operation. Therefore, it is possible to detect any errors caused during drawing inputting/editing operation at an early stage and also possible to restrain processing steps from being increased due to a redo of designs.

In addition, it is possible for the drawing input apparatus to realize improved efficiency of drawing inputting and correcting operations and contribute to an alleviation of a burden on the designer according to the present invention.

Also, since the rule information stored in the rule information storing portion is modifiable, it is desirable for the rule checking portion that, each time the rule information is modified, the drawing data is checked based on the modified rule information.

Thus, the rule information can arbitrarily be changed or modified according the present invention so as to customize checking contents without restraint, thereby enabling contribution to enhanced efficiency of a design working. Incidentally, even if the rule information is modified, a currently inputted or edited drawing may possibly be checked only based on the previous rule information which is not yet modified until the checking operation starts based on that modified rule information. Accordingly, it is not certainly determined whether such a currently inputted or edited drawing infracts the modified and renewed rules. Therefore, if, each time the rule information is modified, the already inputted or edited drawing (or drawing data) is checked based on the modified and renewed rules, then a checking result can rapidly be obtained in compliance with the latest rule information.

In addition, the drawing input apparatus as described above can be configured to further comprise:
a drawing data storing portion adapted to store therein said part which is present in the drawing data and which is modified based on said predetermined operation and a checking result obtained by checking said modified part by said rule checking portion in such a way as to correspond to each other; and
a displaying portion adapted to display the drawing data stored in the drawing data storing portion in a state reflecting the checking result corresponded to the drawing data. Specifically, it is possible to store the checking result obtained by the rule checking portion and the drawing data in a database or the like and then perform management, update, storage and reproduction thereof.

With such a configuration, it is unnecessary for the user to manage a correspondence relationship between data of a part which is present in the drawing data and which is an object to be checked and the checking result for the part as the checking object, thereby eliminating wasted analyzing cost for dealing with mistakes in managing this correspondence relationship. Also, it is possible to rapidly and intuitively comprehend locations which have been inputted or edited with infraction of the rules by displaying the drawing data in a state reflecting the checking result.

Furthermore, in the drawing input apparatus as configured above, it is desirable for the displaying portion to display any locations which are present in the drawing data and which have been inputted or edited with infraction of the rules in a different display form than that for locations without infraction of the rules. More specifically, the display schema of locations infracting the rules is modified by reflecting on the drawing the checking result obtained by the rule checking portion. In particular, locations of the drawing found to be erroneous are displayed in an alarming state while corrected locations of the drawing are displayed in a normal state.

According to another aspect of the present invention, there is provided a drawing input program, characterized by allowing a computer to execute:
a drawing inputting/editing step for inputting/editing drawing data;
a rule information acquiring step for acquiring rule information defining rules for inputting or editing the drawing data; and
a rule checking step for checking by using said rule information a part which is present in the drawing data and which is modified based on a predetermined operation on the condition that such a predetermined operation is executed at said drawing inputting/editing step.

In the drawing input program as described above, said rule information is modifiable and it is desirable to, each time the rule information is modified, check the drawing data based on the modified rule information at said rule checking step.

Also, it is desirable for the drawing input program as described above to further comprise:
a drawing data storing step for storing therein said part which is present in the drawing data and which is modified based on said predetermined operation and a checking result obtained by checking said modified part at said rule checking step in such a way as to correspond to each other; and
a displaying step for displaying the drawing data stored at the drawing data storing step in a state reflecting the checking result corresponded to the drawing data.

Furthermore, it is desirable for the drawing input program to, at said displaying step, display any locations which are present in the drawing data and which have been inputted or edited with infraction of said rules in a different display form than that for locations without infraction of said rules.

According to yet another aspect of the present invention, there is provided a drawing input method, characterized by comprising:
a drawing inputting/editing step for inputting/editing drawing data;
a rule information acquiring step for acquiring rule information defining rules for inputting or editing the drawing data; and
a rule checking step for checking by using said rule information a part which is present in the drawing data and which is modified based on a predetermined operation on the condition that such a predetermined operation is executed at said drawing inputting/editing step.

In the drawing input method as described above, said rule information is modifiable and it is desirable to, each time the rule information is modified, check the drawing data based on the modified rule information at said rule checking step.

Also, it is desirable for the drawing input method as described above to further comprise:
a drawing data storing step for storing therein said part which is present in the drawing data and which is modified based on said predetermined operation and a checking result obtained by checking said modified part at said rule checking step in such a way as to correspond to each other; and
a displaying step for displaying the drawing data stored at the drawing data storing step in a state reflecting the checking result corresponded to the drawing data.

Furthermore, it is desirable for the drawing input method to, at said displaying step, display any locations which are present in the drawing data and which have been inputted or edited with infraction of said rules in a different display form than that for locations without infraction of said rules.

These and other aspects of the present invention will be apparent from the following specific description, given by way of example, with reference to the accompanying drawings.

### BRIEF DESCRIPTION OF THE DRAWINGS

FIG. 1 is a function block diagram illustrating a configuration of a drawing input apparatus according to a preferred embodiment of the present invention;

FIG. 2 is an example of a circuit diagram that will be inputted or edited y the drawing input apparatus according to the preferred embodiment;

FIG. 3 is an example of a rule information file stored in a rule information storing portion;

FIG. 4 is a diagram for illustrating information on constituents of a circuit drawing stored in a library;

FIG. 5 is a flowchart showing the processing flow of the drawing input apparatus;

FIG. 6 is a flowchart for illustrating a detail of a DRC operation in the processing flow as shown in FIG. 5;

FIG. 7 illustrates a display example displayed on a displaying portion for showing a circuit diagram under design;

FIG. 8 is an example of drawing data stored in a drawing data storing portion;

FIG. 9 illustrates inputting or edition of the drawing data by a user;

FIG. 10 is an example of the drawing data stored in the drawing data storing portion;

FIG. 11 shows a correspondence relationship between names of blocks and cells;

FIG. 12 is an example of the drawing data stored in the drawing data storing portion;

FIG. 13 illustrates a drawing display based on a renewed drawing data:

FIG. 14 illustrates a specific example of a DRC after inputting or edition of a drawing;

FIG. 15 illustrates a specific example of the DRC after inputting or edition of a drawing;

FIG. 16 illustrates a specific example of the DRC after inputting or edition of a drawing;

FIG. 17 illustrates a specific example of the DRC after inputting or edition of a drawing;

FIG. 18 illustrates a specific example of the DRC after inputting or edition of a drawing;

FIG. 19 illustrates a specific example of the DRC after inputting or edition of a drawing;

FIG. 20 illustrates a specific example of the DRC after inputting or edition of a drawing;

FIG. 21 illustrates a specific example of the DRC after inputting or edition of a drawing;

FIG. 22 illustrates a specific example of the DRC after inputting or edition of a drawing;

FIG. 23 illustrates a specific example of the DRC after inputting or edition of a drawing;

FIG. 24 illustrates a specific example of the DRC after inputting or edition of a drawing;

FIG. 25 illustrates a specific example of the DRC after inputting or edition of a drawing;

FIG. 26 illustrates a specific example of the DRC after inputting or edition of a drawing;

FIG. 27 illustrates a specific example of the DRC after inputting or edition of a drawing;

FIG. 28 illustrates a specific example of the DRC after inputting or edition of a drawing; and

FIG. 29 is a function block diagram illustrating a configuration of a conventional drawing input apparatus.

### DESCRIPTION OF PREFERRED EMBODIMENTS

Hereinafter, a drawing input apparatus according to a preferred embodiment of the present invention will be described in detail with reference to the accompanying drawings. In this preferred embodiment, a design of a circuit diagram or circuit drawing is exemplified on the condition that various rules for inputting or editing a drawing are defined.

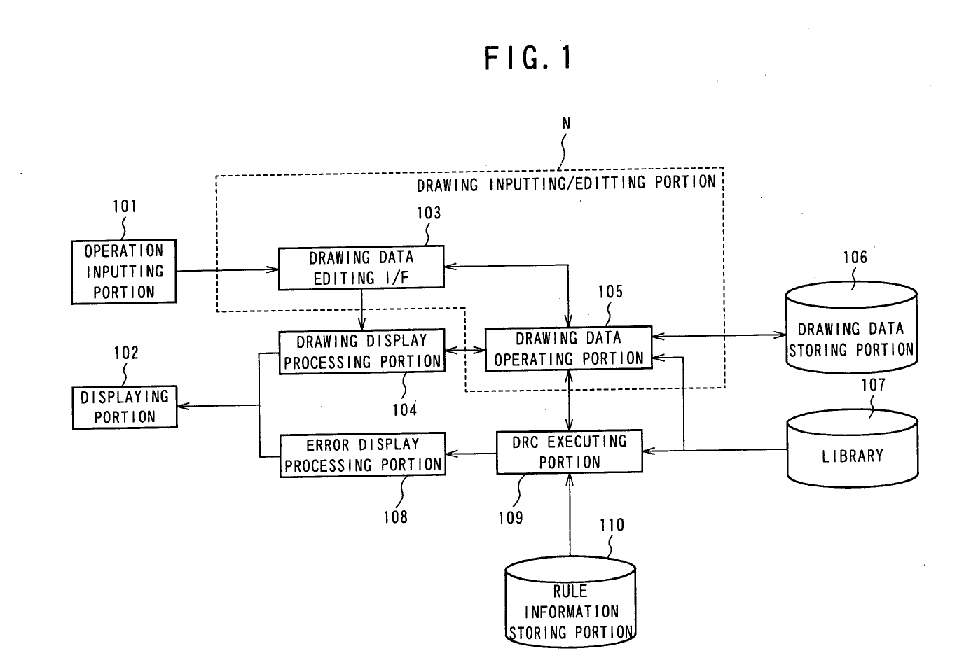

FIG. 1 is a function block diagram illustrating a configuration of the drawing input apparatus according to the preferred embodiment of the present invention.

The drawing input apparatus according to the preferred embodiment, comprise: an operation inputting portion (key-board, mouse and the like) 101, a displaying portion (display etc.) 102, a drawing display processing portion 104, a drawing inputting/editing portion N, a drawing data storing portion 106, a library 107, an error display processing portion 108, a DRC executing portion 109 adapted to execute the DRC operation on an inputted or edited drawing, a rule information storing portion 110, a non-shown storage region, and a no-shown CPU.

In addition, the drawing inputting/editing portion N includes a drawing data editing I/F 103 and a drawing data operating portion 105.

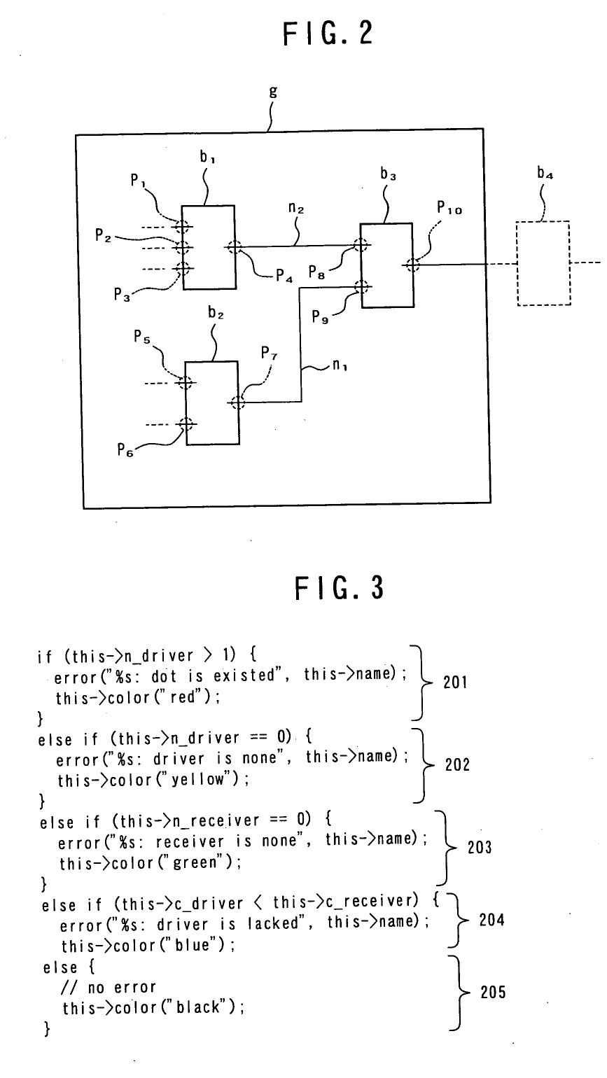

FIG. 2 is an example of the circuit diagram that will be inputted or edited by the drawing input apparatus according to the preferred embodiment. As shown in FIG. 2, the circuit diagram that will be inputted or edited by the drawing input apparatus includes thereon, for example, blocks b1-b3 and nets n1, n2 (wiring or interconnect). These blocks b1-b3 have ports P1-P10 through which they communicate with other blocks and are enabled to be communicate with each other by connecting these ports to each other by using net n1 and the net n2, etc. Also, as shown in FIG. 2, if the entire circuit diagram is not accommodated within a currently displayed page q, some block of block accommodated within the page g may be connected to a block existing in a currently non-displayed page (e.g., a connection between a block b3 and a block b4). With this configuration of the drawing input apparatus, it is possible for a user to arbitrarily input these blocks, nets, ports and pages or edit (addition, deletion, connection, cutting, and deformation) them.

Next, various components of the drawing input apparatus according to the preferred embodiment will be described in detail.

First, the operation inputting portion 101 serves to perform an operation input into the drawing display apparatus and is composed of a key-board and a mouse etc. The displaying portion 102 serves to display the circuit diagram thus inputted or edited on its display screen and is composed of a display.

The drawing inputting/editing portion N has a function to input or edit the circuit diagram. More specifically, editions of respective nets constituting a circuit on the circuit diagram, respective blocks constituting the circuit, respective ports of the blocks, and a page are performed based on user's operational inputs.

The drawing data storing portion 106 serves as a storage region (database) for storing therein data on the drawing or diagram which has been inputted or edited in the drawing inputting/editing portion N. The library 107 serves as a storage region for storing therein information of constituents of the circuit diagram (e.g., information in connection with specifications such as the number of input ports or output ports of blocks constituting the circuit diagram). The rule information storing portion 110 serves as a storage region for storing therein rules focused on nets and rule information file for, upon infraction of the rules, defining how to notify the user of its error (rule information defining rules for inputting or editing the drawing data). These storage regions may be respectively composed of a HDD, RAM and the like.

In addition, the drawing data storing portion 106, the library 107 and the rule information storing portion 110 may be configured within the drawing input apparatus. Otherwise, at least one of these components may be configured by a storage region outside of the drawing input apparatus (e.g., a storage region of a computer disposed outside of the drawing input apparatus).

Next, the drawing data editing I/F 103 serves as an interface for transmitting operational inputs of the operation inputting portion 101 to the drawing display processing portion 104 and the drawing data operating portion 105. The drawing display processing portion 104 serves as an interface for displaying the drawing data on the displaying portion 102.

The drawing data operating portion 105 serves to perform processing of reading and writing of the drawing data, which is stored in the drawing data storing portion 106, based on the operational inputs transmitted through the drawing data editing I/F 103 from the operation inputting portion 101.

The DRC executing portion 109 is able to read the rule information file stored in the rule information storing portion 110 and serves to execute the DRC operation on the circuit diagram (or circuit drawing) inputted or edited based on the rule information.

The error display processing portion 108 serves as an interface for displaying on the displaying portion 102 error information obtained as a result of the DRC operation executed by the DRC executing portion 109.

FIG. 3 is an example of the rule information file stored in the rule information storing portion 110. As shown in FIG. 3, a denotation “this->name” is a name of a net to be checked; a denotation “this->n_driver” is the number of output ports which are connected to that net; a denotation “this->n_receiver” is the number of input ports which are connected to that net; a denotation “this->c_driver” is the total value of drive powers (capacitances) of output ports; a denotation “this->c_receiver” is the total value of input loads (capacitances) of input ports; a denotation “error( )” is a function to output an error message; and a denotation “this->color( )” is a function to change a color of that net and then store that change in the drawing data storing portion.

Hereinafter, design rules ((201)-(205)) defined in the rule information file will be described in detail in conjunction with FIG. 3. These rules are defined with focus on nets of the blocks, not ports thereof.

Rule 201: In the event that there are a plurality of ports particularly having output attributes among ports of blocks connected to the net to be checked (in a state of being DOTted), an error message is outputted, a color of the net is set to red, and its error information is stored in the drawing data storing portion 106;
Rule 202: In the event that there are no ports having output attributes among ports of blocks connected to the net to be checked (in a state of being no drivers), an error message is outputted, the color of the net is set to yellow, and its error information is stored in the drawing data storing portion 106;
Rule 203: In the event that there are no ports having input attributes among ports of blocks connected to the net to be checked (in a state of being no receivers), an error message is outputted, the color of the net is set to green, and its error information is stored in the drawing data storing portion 106;
Rule 204: In the event that the total value of input loads of ports having input attributes among ports of blocks connected to the net to be checked exceeds drive powers of the ports having output attributes (in a state of being lack of drive powers), an error message is outputted, the color of the net is set to blue, and its error information is stored in the drawing data storing portion 106; and
Rule 205: In the event that the net to be checked is in a normal state (i.e., in the case of being not error states like (1)-(4) as mentioned above, the color of the net is set to black (if there has been an error at the previous cycle, an indication color of the error is return to black), and its error information is stored in the drawing data storing portion 106.

A set of the above rules 201-205 is simply an example and, needless to say, it is possible to define any other rules (e.g., in the case of an error, it may include changing a solid line to a broken line, deforming a displaying shape and displaying an alarm etc.), as desired. Since it is possible to arbitrarily set respective checking items of the rule information, an alarming level and any handlings of respective errors, the user can arbitrarily change or modify the rule information so as to customize checking contents without restrain, thereby enhancing design efficiency. For example, when a net which overstrides pages is edited, the resultant alarming messages and lists are outputted. In particular, when a net which is present within the same page is edited, it is possible to execute a processing operation only for coloring. Of course, it is also possible to define rules for collectively delete redundant drawings and dealing with open terminals.

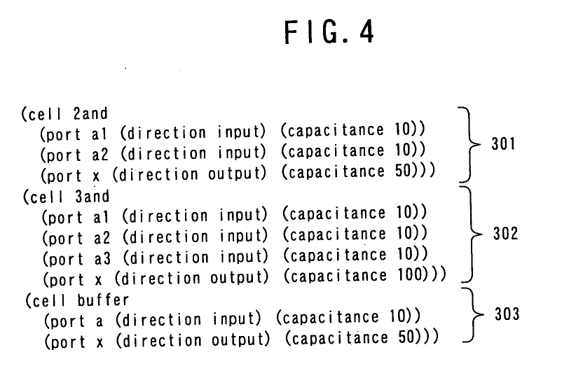

Subsequently, an example ((301)-(303)) of information on constituents of the circuit diagram stored in the library 107 will be described in detail in conjunction with FIG. 4.
301: This is information on a circuit constituent named “2 and” (on a block (cell)). Here, it is defined that, in this “2 and”, a “port a1” is an input port of input load acceptable value “10”, a “port a2” is an input port of input load acceptable value “10”, and a “port x” is an output port of drive power “50”.
302: This is information on a circuit constituent named “3 and”. Here, it is defined that, in this “3 and”, a “port a1” is an input port of input load acceptable value “10”, a “port a2” is an input port of input load acceptable value “10”, a “port a3” is an input port of input load acceptable value “10”, and a “port x” is an output port of drive power “100”.
303: This is information on a circuit constituent named “buffer”. Here, it is defined that, in this “buffer”, a “port a” is an input port of input load acceptable value “10”, and a “port x” is an output port of drive power “50”.

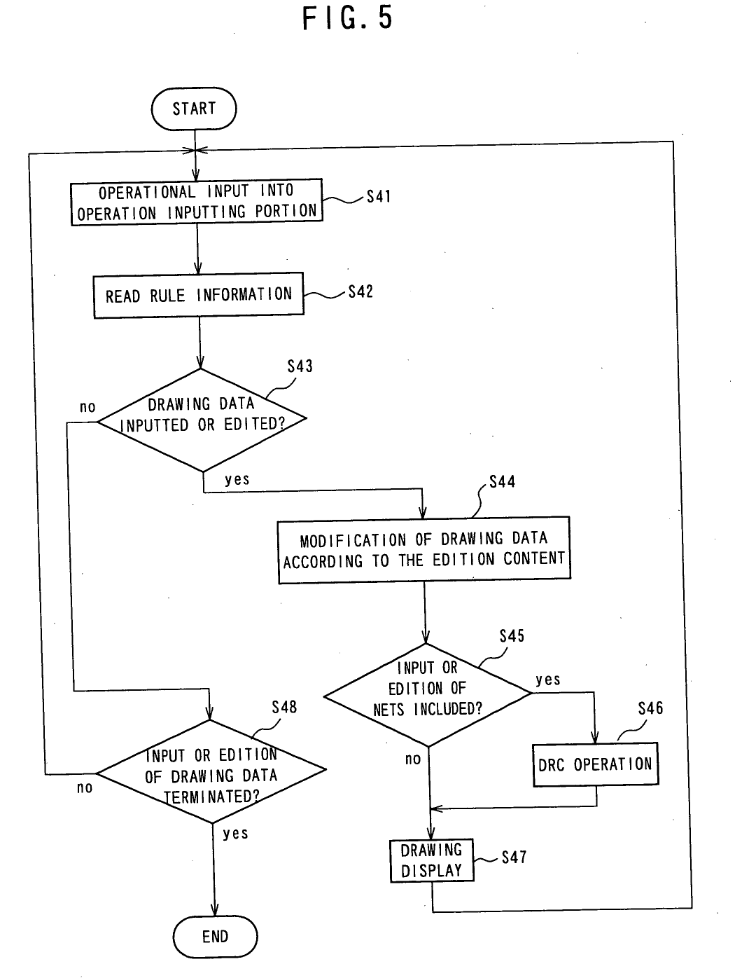

Next, the processing flow of the drawing input apparatus according to the preferred embodiment will be described. FIG. 5 is a flowchart showing the processing flow of the drawing input apparatus.

First, a user's operational input(s) at the operation inputting portion 101 is entered (S41), and then a signal corresponding to that operational input is transmitted through the drawing inputting/editing portion N to the DRC executing portion 109.

The DRC executing portion 109 reads the rule information from the rule information storing portion 110 by taking advantage of, as a cure, transmission of the signal corresponding to the operational input entered into the operation inputting portion 101 through the drawing inputting/editing portion N (i.e., a predetermined operation executed by the drawing inputting/editing portion). This forms a rule information acquiring step (S42) in the preferred embodiment.

When the user inputs or edits drawings (S43: Yes), the drawing data operating portion 105 changes or modifies the content of the drawing data stored in the drawing data storing portion 106 according to the content of the inputting or editing operation previously executed on the drawing data while referencing the information stored in the library 107. This forms a drawing inputting/editing step in the preferred embodiment (S44).

Thereat, if the content of the executed inputting or editing operation includes any input or edition of nets (S45: Yes), then the DRC executing portion 109 executes the DRC operation on the inputted or edited nets while referencing the information stored in the library 107 (S46). More specifically, on the condition that the drawing inputting/editing portion executes a predetermined operation, a part which is present within the drawing data and which is modified based on such a predetermined operation is checked by the DRC executing portion by using the rule information. This forms a rule (-based) checking step in the preferred embodiment. Incidentally, what is meant by the “predetermined operation” referred to as above is an operation that will be executed by the drawing inputting/editing portion N in order to input or edit a drawing. It is arbitrarily possible to set what kind of operation is considered as a cue for starting the rule checking step.

More specifically, the input or edition of nets is classified into four classes: (1) addition of a net; (2) deletion of a net; (3) connection of a net; and (4) disconnection of a net. For example, when a connection relationship of a net is corrected, it may be regarded that both disconnection and connection of that net have simultaneously been executed. Also, when a block is deleted at the time of the edition of blocks, a net connected to a port of that block will be disconnected, as a result of which the net can be regarded to be disconnected.

Furthermore, when a page is deleted at the time of the edition of pages, some blocks existing in the page will simultaneously be deleted, as a result of which it can be regard to be operated in a manner similar to a block deletion operation at the time of the edition of blocks. Similarly, some nets present in the deleted page can also be regarded to be deleted.

After the execution of the DRC operation by the DRC executing portion 109, data on the content of the circuit diagram is displayed on the displaying portion 102 via the drawing display processing portion 104 while error information obtained as a result of the DRC operation is displayed on the displaying portion 102 via the error display processing portion 108 (S47).

In addition, in the event that the content resulted from the input/editing operation does not include any input or edition of nets (S45: No), the content of the drawing data modified according to the content resulted from the input/editing operation is displayed on the displaying portion 102 via the drawing display processing portion 104 (S47).

On the other hand, in the event that the user does not execute the input or edition of a drawing (S43: No), this processing flow will be terminated unless such an inputting/editing operation to acquire the drawing data is executed (S48: Yes) while this processing flow returns to a state of waiting for any operational inputs at the operation inputting portion (S48: No).

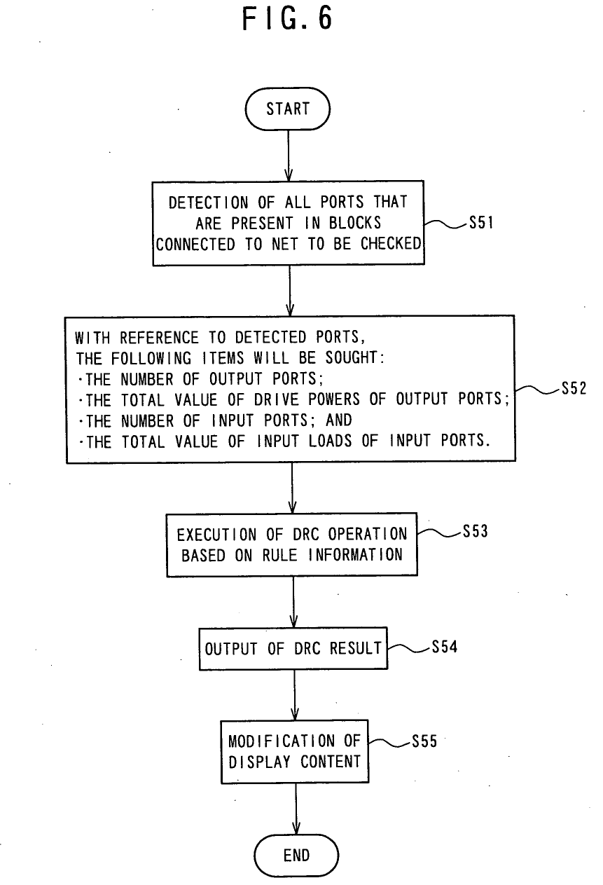

FIG. 6 is a flowchart for illustrating a detail of the DRC operation (S46) in the processing flow as shown in FIG. 5. The DRC executing portion 109 executes the processing steps S51-S54 as follows.

First, in the event that, of nets which have already been inputted or edited, there is a net which has already been inputted have been edited, that net is regard as an object to be checked by the DRC operation. In the event that the deletion of a net has been executed, other nets which have hitherto been connected to the deleted net are regarded as objects to be checked by the DRC operation. More specifically, a modified part of the inputted drawing data can be an object to be checked by the DRC operation and simultaneously other parts which are present in the inputted drawing data and which are not directly modified but influenced by that modification can also be objects to be checked by the DRC operation. Then, all ports that are existed in blocks which have been connected to the net to be checked by the DRC operation are detected (S51).

Subsequently, the following four items will be sought while referencing information stored in the library 107 (S52):
the number of output (driver) ports;
the total value of drive powers of output ports;
the number of input (receiver) ports; and
the total value of input loads of input ports.

Then, the DRC operation is executed based on these sought values and the already read rule information (S53), and the checking result (error information) obtained upon execution of the DRC operation is outputted to the drawing data operating portion 105 and the error display processing portion 108 (S54). In this manner, the DRC operation is not executed on the entire drawing data but is executed only on a modified part of the drawing data according to the present invention, thereby enabling contribution to an alleviation of operation load.

The drawing data operating portion 105 modifies the content of the drawing data stored in the drawing data storing portion 106 based on the error information received from the DRC executing portion 109 (specifically, the drawing data storing portion 106 stores therein the drawing data and the error information corresponded to that drawing data). This forms a drawing data storing step in the preferred embodiment. While the error display processing portion 108 references the error information and the drawing data operating portion 105 references that modified drawing data, the content of the input or edition operation which has been executed on nets by the user is displayed in a state reflecting the result of the DRC operation (S55). More specifically, the drawing data stored in the drawing data storing portion is displayed in a state reflecting the checking result corresponded to that drawing data. This forms a displaying step in the preferred embodiment.

Although the preferred embodiment is configured in such a manner that the DRC operation is executed when the input or edition of nets is executed, the present invention is not limited to that. For example, when the rule content of the rule information is modified, it is possible to execute the DRC operation so as to update error information. More specifically, the present invention can also be configured in such a manner that, each time the rule information is modified, the DRC operation is executed on the drawing data based on that modified rule information.

Next, the processing flow for the DRC operation as mentioned above will be described in detail with reference to its specific example.

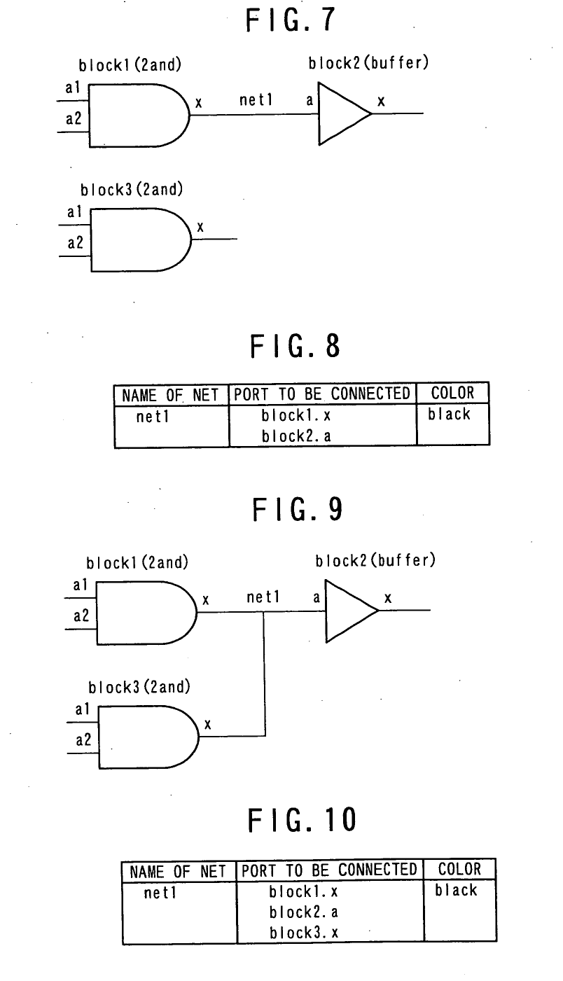

FIG. 7 illustrates a display example on the displaying portion 102 for showing a circuit diagram under design. In FIG. 7, three blocks of “block1(2 and)”, “block2(buffer)” and “block3(2 and)” have already been inputted and, of these blocks, a port of the block1 (block1. x) and a port of the block2 (block2. a) are being connected to each other via a “net1”. In this state, a “block3” is being not yet connected to any blocks.

At this point, the drawing data which is relevant to the “net1” is being stored in a state as shown in FIG. 8. More specifically, the “block1. x” is connected to the “block2. a” via the “net1” and the “net1” is established as being depicted in black color which indicates a normal state.

Here for example, in the event that an operational input is executed so as to connect the port “block3. x” of the “block3” to the “net1” (as shown in FIG. 9), the drawing data which is relevant to the “net1” is established as being in a state as shown in FIG. 10. More specifically, the “block1. x”, “block2. a” and “block3. x” are respectively connected to one another via the “net1” and the “net1” is established as being depicted in black color which indicates a normal state.

The DRC executing portion 109 detects this net “net1” thus edited above as an object to be checked and seeks all ports which are being connected to the “net1”, as a result of which there can be found three ports of the “block1. x”, “block2. a” and “block3. x”.

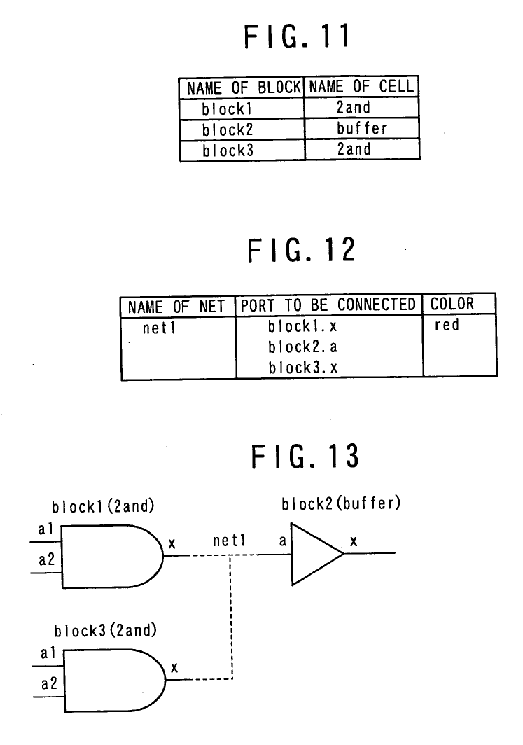

Subsequently, the DRC executing portion 109 seeks the names of cells corresponding to the names of these three blocks according to a correspondence table as shown in FIG. 11 (the sought names: “2and”; “buffer”; and “2and”), and further seeks the following four values in association with the sought names while referencing the information stored in the library 107 (see FIG. 4):
the number of output (driver) ports as being connected to the “net1”;
the total value of drive powers of output ports as being connected to the “net1”;
the number of input (receiver) ports as being connected to the “net1” and
the total value of input loads of input ports as being connected to the “net1”.

More specifically, it can be comprehensible that:
the number of output ports=1(block1. x)+1(block3. x)=2;
the total value of drive powers of input ports=50(block1. x)+50(block3. x)=100;
the number of input ports=1(block2. a); and
the total value of input loads of input ports=10(block2. a).

In particular, information for defining a correspondence relationship between the names of blocks and cells as shown in FIG. 11 may previously be stored in either of the drawing data storing portion 106, the library 107 or the other non-shown storage regions.

The DRC executing portion 109 executes its checking operation based on the values thus obtained as above and the rule information for the design (the design rules) as shown in FIG. 3. Here, since this arrangement of the circuit diagram is in a state in which two ports having output attributes are existed among ports of blocks connected to the net to be checked (in a state of being DOTted), a message “net1: dot is existed” is outputted on the displaying portion 102 and further the drawing data which is relevant to the “net1” and stored in the drawing data storing portion 106 is updated/set (changing a displaying color into a red color).

The drawing data operating portion 105 enables the displaying portion 102 to display on its display screen the circuit diagram based on the drawing data which is relevant to the updated “net1” (see FIG. 13). In FIG. 13, a part of the “net1” which is indicated by broken lines is assumed to be colored in red.

Thus, immediately after the inputting operation or editing operation, it is possible for the user to rapidly comprehend the fact that the last inputting operation or editing operation executed on some locations of the drawing data has infracted the design rules by displaying said some locations that have been inputted or edited with infraction of the design rules, particularly in a different display form than that for locations without any infraction of the design rules.

In addition, even after termination of the inputting operation or editing operation, the display state (updated state) reflecting this error information still remains to be stored in the drawing data storing portion until next time it is updated by a different data. Accordingly, when the inputting operation or editing operation is recommenced, locations which infract the design rules at that point in time are displayed ab initio in a state reflecting the error information even if the DRC operation is not again executed. Therefore, it is possible to readily comprehend problematic locations by changing of its color and/or shape etc. Also, a part which is present in the drawing data and which is an object to be checked and a checking result of the object to be checked (error information) are stored in the drawing data storing portion in such a way as to correspond to each other. No mistake arise in the management of a correspondence relationship between error information with respect to a design miss detected by execution of the DRC operation and the circuit diagram which is to be displayed on the display screen.

Hereinafter, some specific examples of the DRC after inputting or edition will be recited.

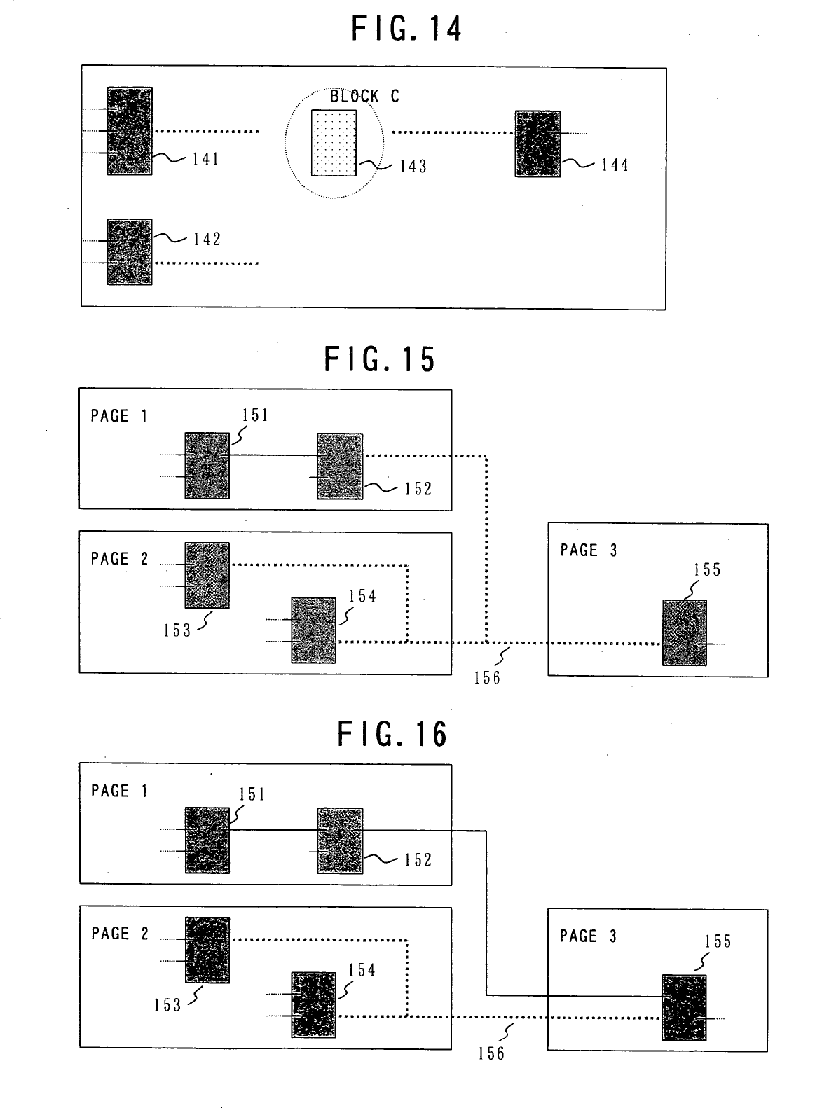

FIG. 14 shows a display example on the displaying portion 102 in the case of deletion of a block 143 where blocks 141, 142, 144 are connected to one another via the block 143. In this example, the deletion of the block 143 leads to a design error because there is present a net but any “DRIVER” and any “RECEIVER” are not existed in the net (see the rules 202 and 203 as shown in FIG. 3).

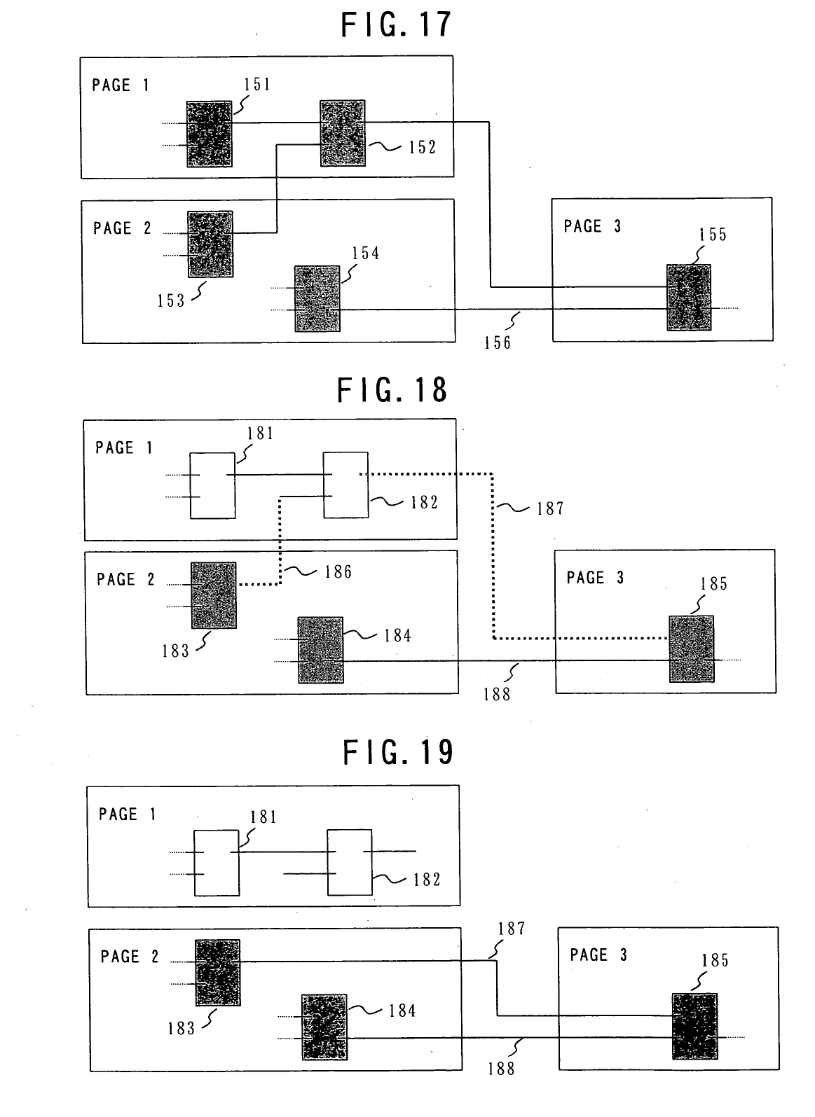

FIG. 15 shows a display example on the displaying portion 102 where respective ports of blocks 153, 154 are connected to a net 156 via which a block 154 is connected to a block 155. In particular, this display example is in a state in which, of ports which are existed in the blocks connected to the net 156, a plurality of ports having output attributes are existed (in a state of being DOTted), thereby leading to a design error (see the rules 201 as shown in FIG. 3). FIG. 16 shows a display example where a connection relationship between the blocks 152 and 155 is corrected. FIG. 17 shows a display example where the blocks 153 and 152 are further connected to one another and a connection relationship between the blocks 154 and 155 is corrected.

FIG. 18 shows a display example on the displaying portion 102 in the case of deletion of page 1 including thereon blocks 181 and 182 in a state in which blocks 181 through 185 exist in such a way to be interconnected to one another via nets 186-188. In this display example, the deletion of the page 1 leads to a design error because there are present nets but any “DRIVER” and any “RECEIVER” are not existed in the nets (see the rules 202 and 203 as shown in FIG. 3). FIG. 19 shows a display example where the net that is in defect of connecting destinations is corrected by appropriately connecting the block 183 to the block 185.

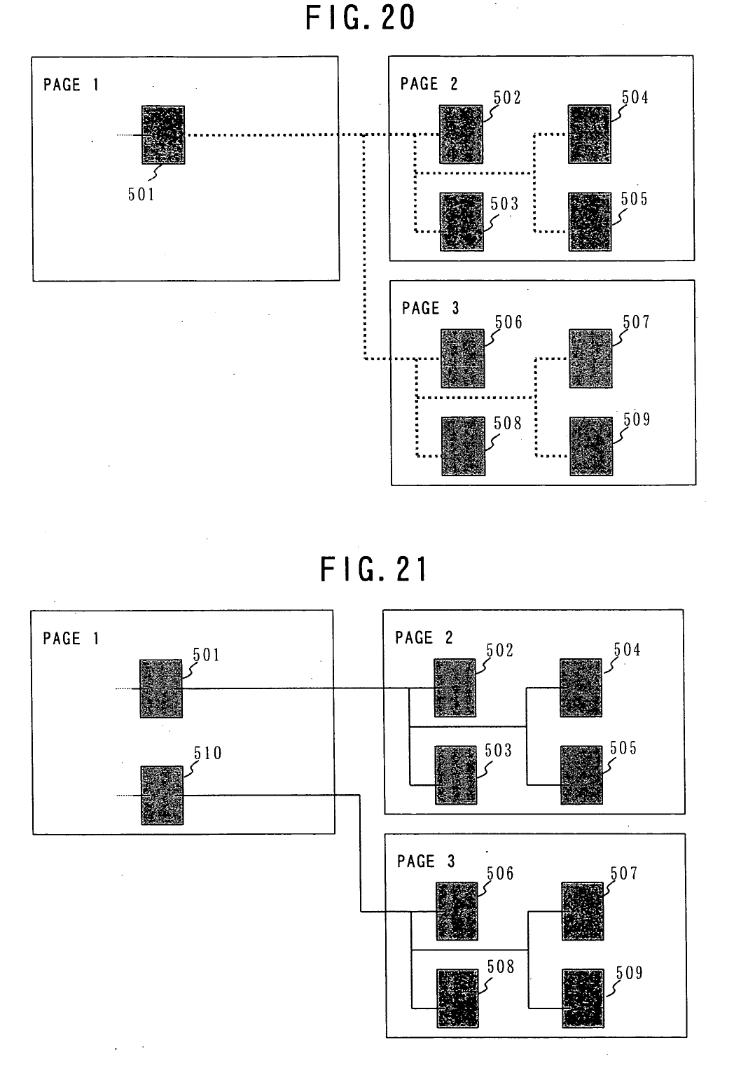

FIG. 20 shows a display example where, in a state in which a plurality of blocks 502-509 are appropriately connected to one another, drive power of a block 501 exceeds or underruns(being short of drive power) the total value of input loads of the blocks 502-509 (serving as receivers). FIG. 21 shows a display example where a block 510 is added to and a connecting destination of the blocks 506-509 is changed from the block 501 to the block 510, thereby correcting the state as shown in FIG. 20 in a manner that drive power is neither too much nor too little.

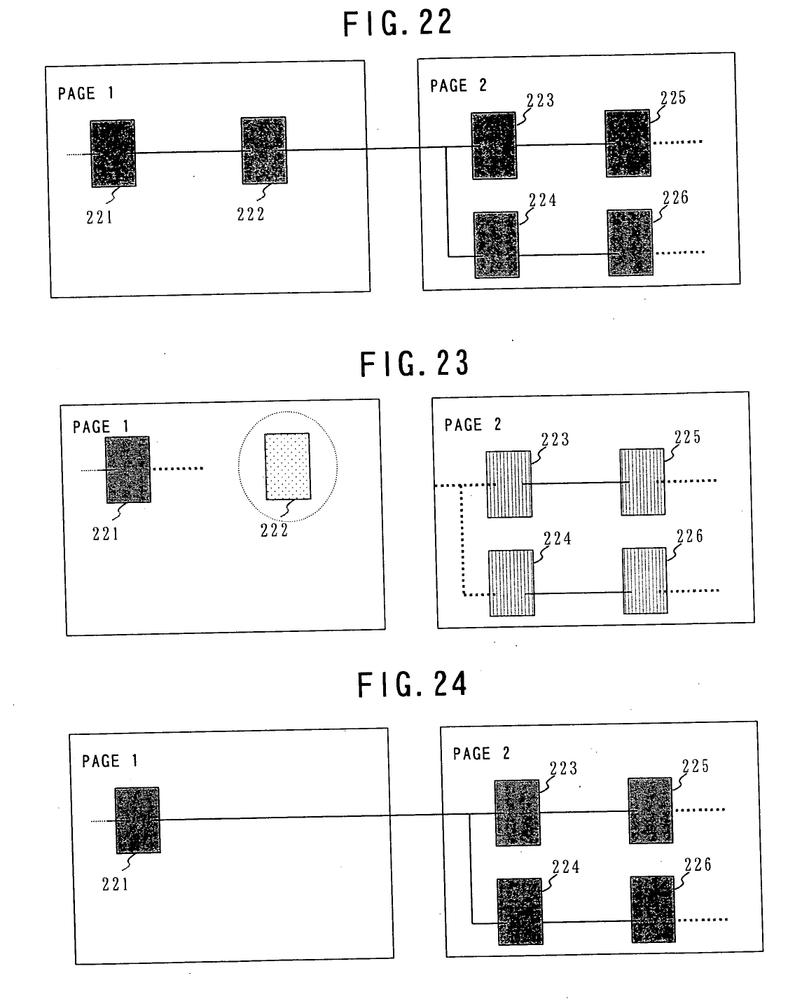

FIG. 22 shows a state in which a block 221 is connected to blocks 223-226 via a block 222. FIG. 23 shows a state in which the block 222 is deleted from the state as shown in FIG. 22, as a result of which, if the resultant blocks 223-226 are completely floated from the other drawings (in a state in which the blocks 223-226 are not connected to any ports of the other blocks), then this FIG. 23 drawing is regarded as a redundant drawing with a design error. FIG. 24 shows a display example where the block 221 is connected to the blocks 223-226, thereby correcting the state in which the blocks 223-226 constitute the redundant drawing as shown in FIG. 23. It should be noted that, if the blocks which constitute a redundant drawing are corrected to be connected to blocks which constitute non-redundant drawing, the redundant drawing is updated as being in a normal state.

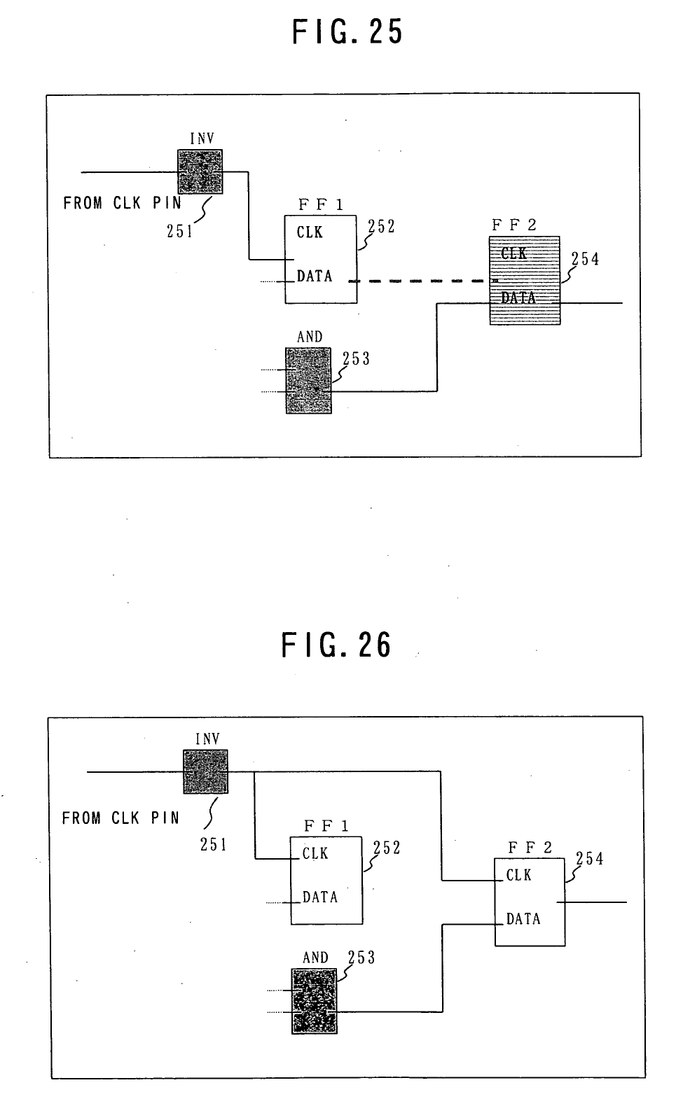

FIG. 25 shows an asynchronous connection state (asynchronous error) in which data outputs of flip-flops FF1(252) and FF2(254) are not synchronous with each other. This means that the state as shown in FIG. 25 infracts connection restriction (based on port attributes and the like). FIG. 26 shows a display example where a connection destination of the flip-flop FF2(254) is corrected to changed from the flip-flop FF1 (252) to an inverter INV(251).

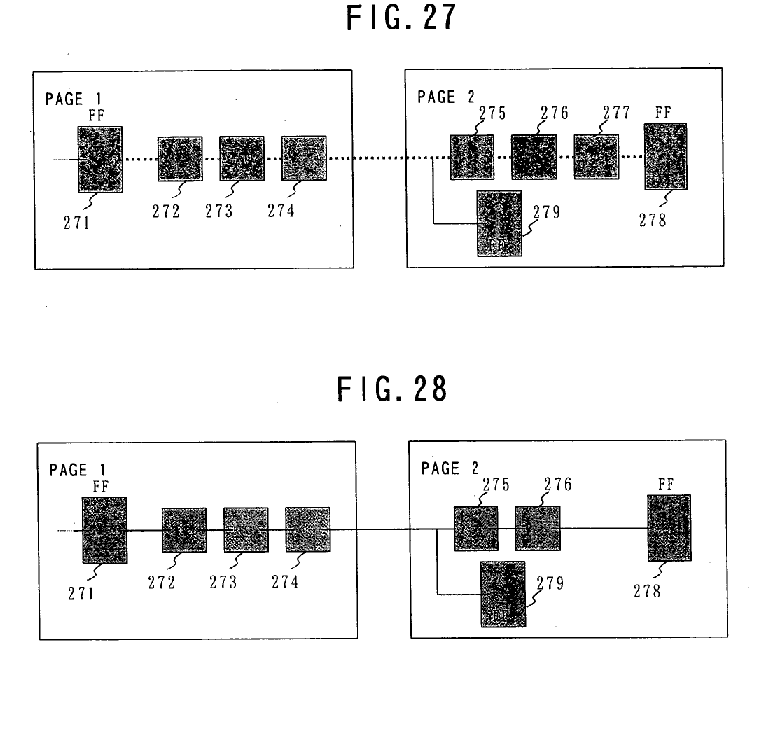

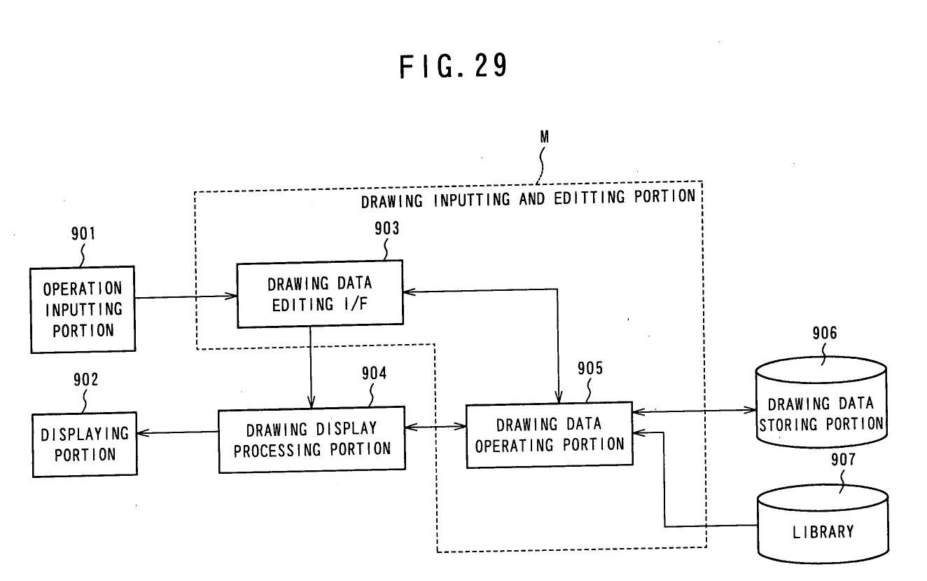

FIG. 27 shows a state in which blocks 272-277 of six stages are disposed between flip-flops 271 and 278 on the assumption that an upper limit of the number of stages between the flip-flops 271 and 278 is set to 5 (error in the number of stages between flip-flops). FIG. 28 shows a display example where the number of stages between the flip-flops is corrected by deleting the block 277 from the state as shown in FIG. 27.

It is possible to define a collision checking of nets and a connection relationship checking (e.g., relationship in that a block A must be connected to a block B) as design rules in addition to ones as above.

In the display examples as shown in FIGS. 14-28, if any error is found in the content of the input or edition resulted from the DRC checking operation, nets having errors are changed in displaying colors by ones in erroneous condition (as indicated by broken lines as shown in FIGS. 14-28) while nets having no errors or nets dissolving errors are changed in displaying colors by ones in normal condition (e.g., black color). In particular, the colors in erroneous condition may be defined by the design rules.

Also, in the above-mentioned preferred embodiment, the error information obtained as a result of the DRC operation is indicated on the circuit diagram displayed on the displaying portion in such a way as to correspond to each other. However, the present invention should not be limited to that configuration. For example, a list of error information and the like may be displayed on the displaying portion in such a manner that any error item can be selected from the list so as to indicate its corresponding location on the circuit diagram.

Also, according to the present invention, it is possible to provide a drawing input method comprising: a drawing inputting/editing step for inputting/editing drawing data; a rule information acquiring step for acquiring rule information defining rules for inputting or editing the drawing data; and a rule checking step for checking by using said rule information a part which is present in the drawing data and which is modified based on a predetermined operation on the condition that such a predetermined operation is executed at said drawing inputting/editing step.

In particular, in above-mentioned drawing input method, the rule information can be modifiable. Therefore, it is desirable to check the drawing data by using the rule information each time the rule information is modified. Also, the drawing input method as described above may be configured to comprise: a drawing data storing step for storing therein said part which is present in the drawing data and which is modified based on said predetermined operation and a checking result obtained by checking said modified part at said rule checking step in such a way as to correspond to each other; and a displaying step for displaying the drawing data stored at the drawing data storing step in a state reflecting the checking result corresponded to the drawing data. In particular, at the displaying step, it is desirable to display any locations which are present in the drawing data and which have been inputted or edited with infraction of said rules in a different display form than that for locations without infraction of the rules.

In addition, the respective steps of the drawing input method according to the present invention can be realized by storing a drawing input program according to the present invention on a non-shown storage region or a storage media in the drawing input apparatus readable by a non-shown CPU (computer) and executing that program by the non-shown CPU. Incidentally, according to the present invention, it will be appreciated by those of ordinary skill in the art that the computer-readable media may comprise any one of a CD-ROM, a flexible disk (FD), a DVD disk, an opto-magnetic disk, a portable storage media such as an IC card and the like, a database storing computer programs, the other computer or its database, or a transmission media on a transmission line.

More specifically, the drawing input program according to the present invention allows a computer to execute: a drawing inputting/editing step for inputting/editing drawing data; a rule information acquiring step for acquiring rule information defining rules for inputting or editing the drawing data; and a rule checking step for checking by using said rule information a part which is present in the drawing data and which is modified based on a predetermined operation on the condition that such a predetermined operation is executed at said drawing inputting/editing step.

In particular, in above-mentioned drawing input program, the rule information can be modifiable. Therefore, it is desirable to check the drawing data by using the rule information each time the rule information is modified. Also, the drawing input program as described above may be configured to comprise: a drawing data storing step for storing therein said part which is present in the drawing data and which is modified based on said predetermined operation and a checking result obtained by checking said modified part at said rule checking step in such a way as to correspond to each other; and a displaying step for displaying the drawing data stored at the drawing data storing step in a state reflecting the checking result corresponded to the drawing data. In particular, at the displaying step, it is desirable to display any locations which are present in the drawing data and which have been inputted or edited with infraction of said rules in a different display form than that for locations without infraction of the rules.

In the preferred embodiment as described above, the library 107 stores therein only basic information (information of the names of pins (ports), their drive powers and input loads) but information of detailed checking rules for the DRC is stored independently from the former information. Therefore, addition or modification of rules for the DRC can be performed by modifying only a rule information file without modification of the information stored in the library.

In the preferred embodiment as described above, an error location is displayed on the displaying portion based on the result obtained whenever the DRC operation is executed each time a net is edited. It is not necessary to equip the drawing input apparatus with a function to perform a processing operation for analyzing error information obtained as a result of the DRC operation and extracting any error.

In the past, a drawing input tool and a DRC tool had to be repetitively operated out of phase with each other so that it was a time-consuming matter to complete or finish a drawing without any infraction of the design rules. However, the drawing input and DRC operations are executed in phase by dynamically executing the DRC operation during the drawing edition (not by a batch processing operation). It is possible to prevent a substantial redo of designs. Also, it is possible to rapidly recognize locations to be required for drawing corrections on occasions when any errors are generated.

Thus, according to the present invention, it is possible to simplify a design flow, prevent design mistakes at the time of a drawing inputting step, facilitate recognition of locations to be required for drawing corrections, as a result of which reduction of design process steps and cost of a design can be realized.

Also, according to the present invention, it is possible to configure the drawing input apparatus to manage error information obtained as a result of the DRC operation so that it enables the drawing input apparatus to readily implement various functions such as a listing function for error locations, high-lighting function for error locations, an auto-focusing function for error locations for the purpose to improve efficiency of a design working.

In addition, in the preferred embodiment as described above, a circuit diagram is recited as an example in the case that rules are defined for inputting or editing a drawing, but the present invention should not be limited to that. The present invention may be applicable to any other examples in which any rules (design rules, restriction matters and the like) are defined for inputting or editing a drawing.

Thus, according to the present invention, it is possible to provide a drawing input apparatus, drawing input program and drawing input method so as to realize an improved efficiency of drawing inputs and correction operations.

While preferred exemplary embodiments of the present invention have been described above, it is to be understood that further adaptations of the invention described herein can be obtained by appropriate modifications by one of ordinary skill in the art without departing from the scope of the present invention. Accordingly, although preferred configurations of apparatus, methods, and programs embodying the present invention have been described, it should be understood that these apparatus, methods, and programs may take on a wide variety of configurations and arrangements without departing from the scope of the present invention. Therefore, the scope of the present invention should be considered in terms of the following claims and should not be limited to the details of the apparatus, methods, and programs shown and described above.

1. A drawing input apparatus comprising:
a drawing inputting/editing portion adapted to input/edit drawing data;
a rule information storing portion adapted to store therein rule information defining rules for inputting or editing the drawing data; and
a rule checking portion adapted to check by using the rule information a part which is present in the drawing data and which is modified based on a predetermined operation on the condition that said drawing inputting/editing portion executes such a predetermined operation.

2. The drawing input apparatus as claimed in claim 1, wherein the rule information stored in the rule information storing portion is modifiable, and each time the rule information is modified, the rule checking portion is configured to check the drawing data based on the modified rule information.

3. The drawing input apparatus as claimed in claim 1, further comprising:
a drawing data storing portion adapted to store therein said part which is present in the drawing data and which is modified based on said predetermined operation and a checking result obtained by checking said modified part by said rule checking portion in such a way as to correspond to each other; and
a displaying portion adapted to display the drawing data stored in the drawing data storing portion in a state reflecting the checking result corresponded to the drawing data.

4. The drawing input apparatus as claimed in claim 3, wherein said displaying portion adapted to display any locations which are present in the drawing data and which have been inputted or edited with infraction of said rules in a different display form than that for locations without infraction of said rules.

5. A drawing input program adapted for allowing a computer to execute:
a drawing inputting/editing step for inputting/editing drawing data;
a rule information acquiring step for acquiring rule information defining rules for inputting or editing the drawing data; and
a rule checking step for checking by using said rule information a part which is present in the drawing data and which is modified based on a predetermined operation on the condition that such a predetermined operation is executed at said drawing inputting/editing step.

6. The drawing input program as claimed in claim 5, wherein said rule information is modifiable and each time the rule information is modified, the drawing data is checked based on the modified rule information at said rule checking step.

7. The drawing input program as claimed in claim 5, further comprising:
a drawing data storing step for storing therein said part which is present in the drawing data and which is modified based on said predetermined operation and a checking result obtained by checking said modified part at said rule checking step in such a way as to correspond to each other; and
a displaying step for displaying the drawing data stored at the drawing data storing step in a state reflecting the checking result corresponded to the drawing data.

8. The drawing input program as claimed in claim 7, wherein said displaying step for displaying any locations which are present in the drawing data and which have been inputted or edited with infraction of said rules in a different display form than that for locations without infraction of said rules.

9. A drawing input method comprising:
a drawing inputting/editing step for inputting/editing drawing data;
a rule information acquiring step for acquiring rule information defining rules for inputting or editing the drawing data; and
a rule checking step for checking by using said rule information a part which is present in the drawing data and which is modified based on a predetermined operation on the condition that such a predetermined operation is executed at said drawing inputting/editing step.

10. The drawing input method as claimed in claim 9, wherein said rule information is modifiable and each time the rule information is modified, the drawing data is checked based on the modified rule information at said rule checking step.

11. The drawing input method as claimed in claim 9, further comprising:
a drawing data storing step for storing therein said part which is present in the drawing data and which is modified based on said predetermined operation and a checking result obtained by checking said modified part at said rule checking step in such a way as to correspond to each other; and
a displaying step for displaying the drawing data stored at the drawing data storing step in a state reflecting the checking result corresponded to the drawing data.

12. The drawing input method as claimed in claim 11, wherein said displaying step for displaying any locations which are present in the drawing data and which have been inputted or edited with infraction of said rules in a different display form than that for locations without infraction of said rules.
